(19) United States
(12) Patent Application Publication
(10) Pub. No.: US 2015/0248048 A1
(43) Pub. Date: Sep. 3, 2015

(54) APPARATUS FOR AFFIXING A CAMERA

(71) Applicant: SENA TECHNOLOGIES INC., Seoul (KR)

(72) Inventor: Oh Jin Jung, Seoul (KR)

(73) Assignee: SENA TECHNOLOGIES INC., Seoul (KR)

(21) Appl. No.: 14/634,275

(22) Filed: Feb. 27, 2015

(30) Foreign Application Priority Data
Feb. 28, 2014 (KR) 10-2014-0024537

(51) Int. Cl. G03B 17/56

(52) U.S. Cl. CPC G03B 17/561

(57) ABSTRACT

Provided is an apparatus capable of fixedly affixing a camera onto an uneven surface or surfaces that are of different angles or heights to each other, while allowing for a high degree of freedom of movement. The apparatus includes a camera connection platform equipped with a camera mounting unit in the upper portion of the apparatus onto which a camera is securely fixed; an upper body pan connected to the lower portion of the camera connection platform that allows the upper body an to pivot multi-axially, a lower body part connected to the lower portion of the upper body part; two legs connected to both ends of the lower body part in a o manner that allows the legs to pivot multi-axially; and suction cups, each of which is attached to each of the other ends of the two supports.

### CROSS-REFERENCE TO RELATED APPLICATION

This application claims priority from Korean Patent Application No. 10-2014-0024537, filed on Feb. 28, 2014, in the Korean Intellectual Property Office, the disclosure of which is incorporated herein by reference in its entirety.

### BACKGROUND

1. Field

The following description relates to an apparatus for affixing a camera, and more particularly, to an apparatus for securing a camera in position by firmly adhering the apparatus on a target surface.

2. Description of the Related Art

Generally, a camera user holds the camera with both hands When recording a video or taking a picture. In a case where a surveillance camera, such as a CCTV, which takes photos of a particular place for a long period of time for the purpose of security and surveillance or when a camera user tries to capture a frontal shot while working on a task with both hands, the user cannot simultaneously hold the camera and capture the image, and thus the user must fix the camera in position on a wall, a helmet, or the like, wherein an apparatus for securing the camera can he used for such purposes.

FIG. 1 shows an example of the aforementioned apparatus for affixing a camera. The apparatus as shown in FIG. 1 may include a top plate onto which a camera is mounted, a support frame to support the top plate, and a suction cup connected to the support frame. The apparatus is configured to be fixed onto a target surface of an object, such as a wall or ceiling of a building, a helmet, or the like, and to enable the shooting angle of the camera to be adjusted within a predetermined range.

However, such an apparatus that has only a single suction cup cannot adhere firmly onto a surface, and thus the suction cup easily comes off over time. In addition, such an apparatus has a low degree of freedom which limits its shooting angle shooting.

To address such drawbacks, an apparatus with two legs for affixing a camera, as described in FIG. 2, has been disclosed. Although the two legs of the apparatus of FIG. 2 adhere firmly onto the same flat surface, it is difficult to affix the legs onto surfaces that are of different angles or heights to each other, such as different sides of a corner of an object, or onto a free-form curved surface, and thus firm affixment of the apparatus cannot be ensured.

### SUMMARY

The following description relates to an apparatus for affixing a camera, or more specifically, an apparatus which is capable of affixing, with a high degree of freedom, a camera onto uneven surface or surfaces that are of different angles or heights to each other. This freedom allows for the user to freely adjust the shooting angle of the camera.

In one general aspect, there is provided an apparatus for affixing a camera, including; to camera connection platform equipped with a camera mounting unit on an upper portion to which a camera is securely fixed; an upper body part connected to as lower portion of the camera connection platform in a manner that allows for the upper body part to pivot multi-axially; a lower body part connected to a lower portion of the upper body part; two legs each connected to each of the two ends of the lower body part in a manner that supports multi-axially pivoting and suction cups, each of which is attached to each of the other ends of the two supports.

The camera connection platform may have a ball formed at the lower portion, and the upper body pan may be shaped to cradle the ball.

The suction cup may be hinged to the leg in a manner that allows for vertical pivoting.

Each of the two legs may have a ball formed at one end and each of the two ends of the lower body part may be shaped to cradle the ball.

Other features and aspects will be apparent from the following detailed description, the drawings, and the claims.

### BRIEF DESCRIPTION OF THE DRAWINGS

FIG. 1 is a perspective view of an example of a general apparatus for affixing a camera.

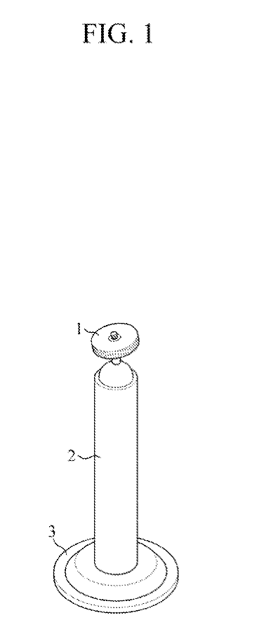

FIG. 2 is a perspective view of another example of a general apparatus for affixing a camera.

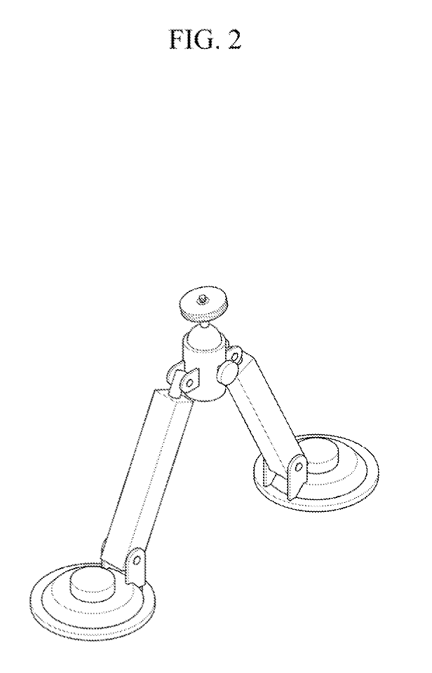

FIG. 3 is a perspective view of an apparatus for affixing a camera according to an exemplary embodiment.

FIG. 4 is a cross-sectional view of the apparatus of FIG. 3,

FIG. 5 is a diagram illustrating the apparatus of FIG. 3 being attached to a target surface.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining, a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

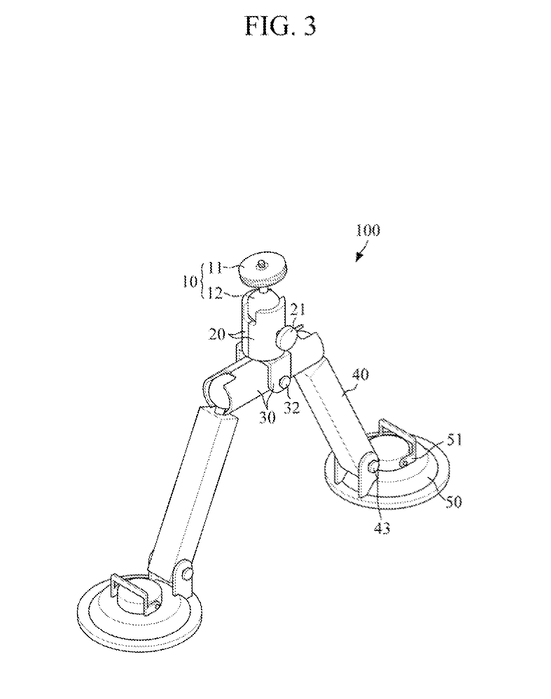

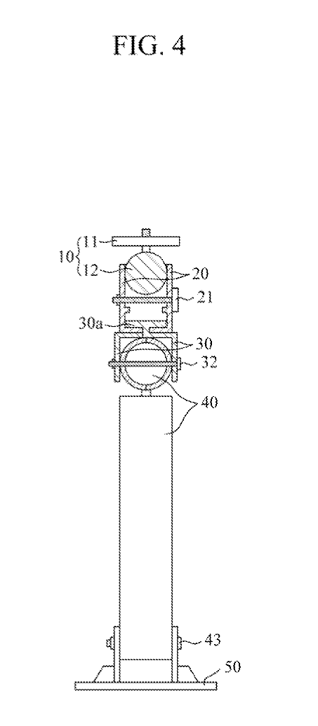

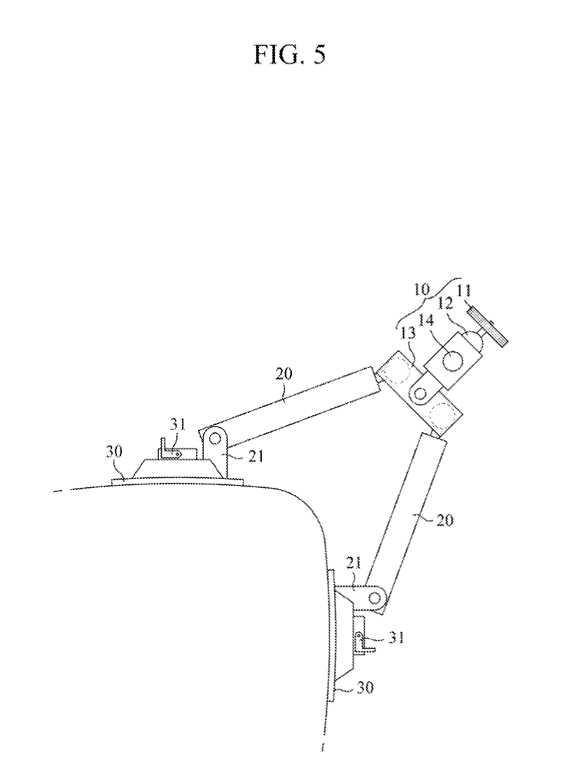

FIG. 3 is a perspective view of an apparatus for affixing a camera according to an exemplary embodiment; FIG. 4 is a cross-sectional view of the apparatus of FIG. 3; and FIG. 5 is a diagram illustrating the apparatus of FIG. 3 being attached onto a target surface.

Referring to FIGS. 3 to 5, the apparatus 100 for affixing a camera includes a camera connection platform 10, an upper body part 20, a lower body part 30, two legs 40, and suction cups 50.

The camera connection platform 10 is equipped with a camera mounting unit 11 on the upper portion thereof to which a camera is fixedly secured. The camera mounting unit 11 is comprised of a camera mount and a male screw protruding from the center of the camera mount to be engaged with a female screw in a tripod socket.

The upper body part 20 is coupled to a lower part of the camera connection platform 10 in such a manner that the camera connection platform 10 can pivot multi-axially with respect to the upper body part 20. As shown in FIGS. 3 to 5, the camera connection platform 10 includes a ball 12 at the lower part thereof, and the upper body part 20 is shaped to cradle the ball 12 such that the upper body part 20 attached to the camera connection platform 10 allows the camera connection platform 10 to multi-axially rotate. The mounting between the tipper body part 20 and the camera connection platform 10, which enables the multi-axial pivoting, may contribute to a higher degree of freedom of the apparatus 100, making it possible to freely adjust the shooting angle of the camera.

In addition, the upper body part 20 has a first fastening screw 21 on a side thereof to fix the shooting angle of the camera by securing, the camera connection platform 10 in a desired position. When the first fastening screw 21 is tightened, the upper body part 20 adds pressure to the ball 12 of the camera connection platform 10, so that the camera connection platform 10 is restricted from moving and is fixed to a particular position.

The lower body part 30 is coupled to a lower area of the upper body part 20. As shown in FIG. 4, the lower body part 30 has an upper stopper 30a that can be pushed further into the upper body part 20 and caught in the cavity of the upper body part 20. In addition, the surface of the stopper 30a and the corresponding surface of the upper body part 20 may have sawtooth projections which prevent the shooting angle of the camera from being changed due to a slip phenomenon that the lower body part 20 rotates with respect to the upper body part 20.

In addition, as shown in FIGS. 3 to 5, the lower body part 30 may have a second fastening screw 32 on one side to secure a leg 40 so as to fix the shooting angle of the camera. As the second fastening screw 32 is tightened, the lower body part 30 adds pressure to the leg 40 so that the leg 40 is restricted from moving and is thus fixed into position.

Both legs 40 are attached to lower body part 30, whereby each of the legs 40 are jointed to each end of the lower body part 30 and can pivot multi-axially. As shown in FIGS. 3 to 5, each lea 40 may have a ball formed at one end thereof, and each end of the lower body part 30 may be shaped to cradle the ball. The multi-axially pivotable ball-connections, or joints, between the legs 40 and both ends of the lower body part 30 may allow for a high degree of freedom to the apparatus 100, thereby making, it possible for a user to freely adjust the shooting angle of the camera.

Furthermore, two legs 40 are provided in the apparatus, and upon these two legs 40, the combined weight of the camera, camera connection platform 10, upper body part 20, and lower body part 30 is distributed, thus allowing the camera to be securely fixed and supported.

Furthermore, although not illustrated, each leg. 40 consists of multiple segments and may thus be adjustable in length. When the length of a leg 40 is adjusted, height adjustment and leveling, of the leg 40 may be efficiently performed in accordance with the height of an attachment surface. More specifically, the leg 40 may consist of a first support rod for which its one end is connected to the lower body part 30 via a joint, and a second support rod that is enveloped in the first support rod through an opening, allowing the length of the leg 40 to be adjusted by sliding the second support rod in and out of the first support rod.

A suction cup 50 is attached to the other end of each leg 40. As shown in FIGS. 3 to 5, the suction cup 50 is hinged to the leg 40 in a manner which allows for the suction cup to pivot vertically, and in turn, allows for adjustment of the attachment angle relative to a target surface. Moreover, the suction cup 50 may further include a third fastening screw 43 to securely fix the suction cup 50 in a position while preventing the suction cup 50 from vertically pivoting with respect to the leg 40.

In addition, referring to FIGS. 3 to 5, the apparatus 100 further includes a suction lever 51 that increases or releases suction so as to enable the suction cup 50 to be easily attached to or detached from the target surface. The material, form, and detailed structure of the suction cup 50 are well known, and thus detailed descriptions thereof will be omitted.

In the apparatus 100 for affixing a camera in accordance with the above exemplary embodiments, two legs 40, each of which have suction cups 50 at one end, are attached to the lower body part 30 in such a manner that allows for multi-axially pivoting with respect to the lower body part 30; the upper body part 20 is connected to the camera connection platform 10 in a manner that allows for it to pivot multi-axially, so that the apparatus 100 maintain strong suction while being able to move a high degree of freedom. Therefore, even in a situation where a target surface, to which the apparatus 100 is attached, is uneven, such as a free-form curved surface as shown in FIG. 5, or surfaces to which each leg 40 is attached are different, such as different sides of a corner of the wall, the camera can be securely fixed in place. Furthermore, it is possible to freely adjust the shooting angle of the camera.

According to the exemplary embodiments, it is possible to securely fix a camera in place even when target surfaces to which each leg is attached are different from each other or the target surface is uneven, such as a free-form curved surface.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for affixing a camera, comprising:
a camera connection platform equipped with a camera mourning unit on an upper portion to which a camera is securely fixed;
an upper body part connected to a lower portion of the camera connection platform in a manner that allows for the upper body part to pivot multi-axially;
a lower body part connected to a lower portion of the upper body part;
two legs each connected to each of the two ends of the lower body part in a manner that supports multi-axially pivoting; and
suction cups, each of which is attached to each of the other ends of the two supports.

2. The apparatus of claim 1, wherein the camera connection platform has a ball formed at the lower portion, and the upper body part is shaped to cradle the ball.

3. The apparatus of claim 1, wherein the suction cup is hinged to the leg in a manner that allows for vertical pivoting.

4. The apparatus of claim 1, wherein each of the two legs has a ball formed at one end and each of the two ends of the lower body part is shaped to cradle the ball.
